(19) United States
(12) Patent Application Publication
(10) Pub. No.: US 2007/0178308 A1
(43) Pub. Date: Aug. 2, 2007

(54) GERMANIUM NANOPARTICLES AND BIOSUBSTANCE LABELING AGENT BY USE THEREOF

(75) Inventors: Naoko FURUSAWA, Tokyo (JP); Yasushi NAKANO, Tokyo (JP); Kazuya TSUKADA, Kanagawa (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 11/622,176

(22) Filed: Jan. 11, 2007

(30) Foreign Application Priority Data
Jan. 27, 2006 (JP) JP2006-019803

(51) Int. Cl. B32B 15/02; B32B 17/02; B05D 7/00

(52) U.S. Cl. 428/403; 428/404; 427/212

(57) ABSTRACT

Nanoparticles are disclosed, comprising a core and a shell, wherein the core comprises germanium (Ge) and the shell comprises an inorganic material, and the nanoparticles exhibit an average core size of 1 to 50 nm. A biosubstance labeling agent by use thereof is also disclosed.

This application claims priority from Japanese Patent Application No. JP2006-019803 filed on Jan. 27, 2006, which is incorporated hereinto by reference.

### FIELD OF THE INVENTION

The present invention relates to germanium nanoparticles and reagents for labeling biosubstances by use of the same.

### BACKGROUND OF THE INVENTION

As is well known, semiconductor nanoparticles, the particle size of which is at the nanometer size level, exhibit quantum size effects such as increased band gap energy, resulting in optical characteristics, for example, superior light absorption characteristics and emission characteristics. Recently, there have been actively made studies of semiconductor nanoparticles. Specifically, semiconductor nanoparticles such as CdSe/ZnS type semiconductor nanoparticles and Si/SiO₂ type semiconductor nanoparticles were studied with respect to various uses, for example, for display panels or LED.

There was also studied a method of using a biosubstance labeling agent, as a means for labeling biosubstance, in which a molecular label substance was bonded to a marker substance. However, marker substance used in this method, such as organic fluorescence dyes exhibited disadvantages such as being markedly deteriorated and short life upon exposure to ultraviolet rays and also resulted in lowered emission efficiency and insufficient sensitivity.

Accordingly, a method of using semiconductor nanoparticles as the foregoing marker substance has recently been noted. For instance, a biosubstance labeling agent in which a polymer containing a polar functional group is physically and/or chemically attached to the surface of semiconductor nanoparticles was studied, as disclosed in JP-A No. 2003-329686 (hereinafter, the term JP-A refers to Japanese patent Application Publication). There was also studied a biosubstance labeling agent of an organic molecule attached to the surface of Si/SiO₂ type semiconductor nanoparticles, as disclosed in JP-A No. 2005-172429.

### SUMMARY OF THE INVENTION

There were problems in the foregoing biosubstance labeling agents using semiconductor nanoparticles. For instance, when semiconductor nanoparticles inclusive of effects, as described in JP-A No. 2003-329686, which are CdSe/ZnS type semiconductor particles, are used as a biosubstance labeling agent, the surface thereof is covered with organic molecules, but materials used with semiconductor nanoparticles, particularly CdSe is pointed out as being essentially biotoxic and environmental loading, and thus produces problems in use as a biosubstance labeling agent.

Si/SiO₂ type semiconductor nanoparticles described in JP-A No. 2005-172429 use silicon (Si) as a core material. This silicon is sometimes excessively reactive other substances, e.g., oxygen. For example, when exposed to ultraviolet rays in an aqueous dispersion, problems arise, for example, deterioration of emission characteristics.

Accordingly, it is an object of the present invention to provide semiconductor nanoparticles exhibiting reduced biotoxity or environmental loading and enhanced stability.

The inventors have made studies to overcome the foregoing problems and discovered that specific semiconductor nanoparticles comprising a core of germanium (also denoted as Ge) and a shell comprising an inorganic material other than germanium, exhibited neither biotoxity nor environmental loading and was superior in chemical stability, resulting in superior optical characteristics such as emission intensity, whereby the present invention has come into being.

Thus, one aspect of the invention is directed to germanium nanoparticles comprising a core formed of germanium and a shell formed of an inorganic material other than germanium, in which the core exhibits an average particle size of 1 to 50 nm.

The inorganic material forming the shell, other than germanium, is preferably an inorganic compound. Such an inorganic compound is preferably germanium dioxide (GeO₂). The shell thickness is preferably in the range of 1 to 50 nm. The surface of the shell may be hydrophilized.

The germanium nanoparticles are bonded to a molecular label substance via an organic molecule and are thereby usable as a biosubstance labeling agent. The germanium nanoparticles can be prepared preferably through a reversed micelle method.

The germanium nanoparticles of the invention exhibit minimized biotoxity or reduced environmental loading and superior chemical stability, resulting in enhanced emission intensity but minimized lowering of emission intensity when subjected to light exposure.

### PREFERRED EMBODIMENTS OF THE INVENTION

The invention will be further described in detail.

In the invention, the expression, A/B type nanoparticles represents nanoparticles comprised of a core composed of A and a shell composed of B. For example, Ge/GeO₂ type nanoparticles mean nanoparticles which comprise a core composed of Ge and a shell composed of GeO₂.

The nanoparticle (or nano-sized particle) of the invention refers to an ultramicroparticle exhibiting a particle size on the nanometer order.

The core of the core/shell germanium nanoparticles of the invention is composed of germanium (Ge). The germanium (Ge) is preferably crystalline germanium. The crystalline germanium may be in the form of a single crystal or a polycrystal, of which the single crystals are preferred, resulting in reduced half-width of emission spectrum.

The germanium forming the core exhibits a purity of at least 90%, preferably at least 95%, and more preferably at least 99%.

The average particle size of the core composed of germanium is preferably from 1 to 50 nm, more preferably from 1 to 20 nm, and still more preferably from 2 to 12 nm. The core is assumed to be spherical or approximately spherical and the particle size of the core represents a diameter of the particle. An average core particle size of not less than the above-described lower limit enables easier control of the particle size, resulting in reduced scattering of particle size. An average particle size of not more than the above-described upper limit results in superior optical characteristics such as enhanced emission efficiency.

The shell of the core/shell germanium nanoparticles of the invention is composed of an inorganic material other than germanium. The inorganic material other than germanium refers to an inorganic material other than a single substance of germanium. Preferably, inorganic compounds other than germanium are used as the inorganic material.

The foregoing inorganic compounds are preferably those exhibiting a band gap greater than that of germanium of the core. Examples of such inorganic compounds exhibiting a greater band gap include GeO₂, SiO₂, a mixed crystal of GeO₂ and SiO₂, AlN, AlP, AlAs, AlSb, GaN, GaP, GaAs, InP, ZnO, ZnS, ZnSe, ZnTe, CdS, CdSe and CdTe. Of these, GeO₂, SiO₂, or a mixed crystal of GeO₂ and SiO₂ are preferred, and GeO₂ is specifically preferred. GeO₂ exhibits a greater band gap than Ge and also has a lattice spacing close to that of Ge, resulting in reduced lattice deformation on the connection face (or the interface) of the core and the shell, rendering it difficult to form crystal defects.

The shell thickness is not specifically limited but the average shell thickness is preferably from 1 to 50 nm and more preferably from 2 to 10 nm. An average shell thickness of not less than the foregoing lower limit is sufficient as the shell, not causing chemical reaction of Ge forming the core with other materials or lowering of emission intensity during light exposure. An average shell thickness of not more than the foregoing upper limit exhibits sufficient optical characteristics of nanoparticles.

Methods of preparing nanoparticles of a core/shell structure of the invention include, for example, a reversed micelle method, a chemical vapor deposition (CVD) method, a hot soap method and a laser ablation method.

In the preparation of Ge/GeO₂ type nanoparticles by the reversed micelle method, for example, reversed micelles of a germanium salt, e.g., GeCl₄ are formed in the presence of a surfactant in an organic solvent, and then ultramicroparticles of germanium (Ge) are formed by using a reducing agent, thereafter, the germanium ultramicroparticles are subjected to a surface oxidation treatment, whereby Ge/GeO₂ type nanoparticles are obtained.

Oil-soluble surfactants are preferably used as the foregoing surfactant. Specific examples of an oil-soluble surfactant include sulfonates, e.g., sodium bis(2-ethylhexyl)sulfosuccinate; quaternary ammonium salts, e.g., tetraoctylammonium bromide (hereinafter, also denoted simply as TOAB) and cetyltrimethylammonium bromide; and ethers, e.g., pentaethylene glycol decyl ether.

Water-insoluble organic solvents capable of dissolving the foregoing surfactants are preferred as the organic solvent. Specifically, alkanes and ethers are preferred. Alkanes having 7 to 12 carbon atoms are preferred. Specific examples thereof include heptane, octane, nonane, decane, isooctane, undecane and dodecane. Ethers having 4 to 8 carbon atoms are also preferred and specific examples thereof include diethyl ether, dipropyl ether and dibutyl ether. The surfactant content in an organic solvent is preferably from 20 to 200 g/liter.

Examples of a reducing agent usable in the invention include lithium aluminum hydride, alkali metal or alkaline earth metal such as Mg or Ca and carbonyl compounds of these metals, alkali or alkaline earth metal hydrides and sodium naphthalide, of which lithium aluminum hydride is preferred.

To obtain Ge/GeO₂ type nanoparticles having a core particle size falling within the foregoing range of 1 to 50 nm through the above-described reversed micelle method, it is preferred to maintain a temperature within the range of 20 to 105° C. at a weight ratio of toluene:TOAB:GeCl₄=100:2:0.2.

Formation of a shell of GeO₂ on the core surface is achieved by oxidation in an atmosphere of an oxidizing gas such as ambient air, oxygen-enriched air or in an oxygen atmosphere. Oxidation in an atmosphere of heated and/or compressed air, oxygen-enriched air or oxygen results in an increased shell thickness of GeO. To achieve a shell thickness of 1 to 50 nm, oxidation may be performed in an ambient air atmosphere at a temperature of 200 to 400° C. for 1 to 60 min. The thus obtained Ge/GeO₂ type nanoparticles exhibit superior chemical stability. For instance, even when exposed to ultraviolet rays in an aqueous dispersion, Ge/GeO₂ nanoparticles scarcely cause deterioration of emission intensity, as compared to Si/SiO₂ type nanoparticles.

The overall particle size of germanium nanoparticles of a core/shell structure of the invention is usually within the range of 3 to 60 nm, and preferably 3 to 20 nm. The nanoparticles are assumed to be spherical or approximately spherical and the particle size thereof represents a diameter of the particle. A particle size falling within the foregoing range, which is nearly equivalent to the size of DNA or an antibody being the objects of labeling, is preferred.

The germanium nanoparticles of a core/shell structure of the invention exhibit neither biotoxity nor environmental loading, scarcely cause chemical reaction such as deterioration reaction, resulting in enhanced emission intensity and minimized lowering of emission intensity during light exposure.

The shell surfaces of the germanium nanoparticles of the invention usually exhibit hydrophobicity. When used as a biosubstance labeling agent, the nanoparticles as such are poorly dispersed in water, producing problems such as aggregation of the particles. Accordingly, it is preferred to subject the shell surface to a hydrophilization treatment.

Methods for hydrophilization include, for example, a technique in which a surface modifying agent is chemically and/or physically bonded to the particle surface. As such a surface modifying agent usable are compounds containing a hydrophilic group of a carboxyl or amino group. Specific examples thereof include mercaptopropionic acid (e.g., 2-mercaptopropionic acid), mercaptoundecanoic acid (e.g., 11-mercaptoundecanoic acid) and aminopropanethiol (e.g., 3-aminopropanethiol). Specifically, for example, 10⁻⁵ g of Ge/GeO₂ type nanoparticles is dispersed in 10 ml of pure water containing 0.2 g of mercaptoundecanoic acid and stirred at 40° C. for 10 min. to perform modification of the shell surface of the nanoparticles via a carboxyl group.

The biosubstance labeling agent of the invention can be obtained by allowing the thus hydrophilized core/shell type germanium nanoparticles to be attached to a molecular label substance via an organic molecule.

The biosubstance labeling agent enables labeling a biosubstance through the molecular label substance being specifically bonded to and/or reacted with a target biosubstance.

Examples of a molecular label substance include a nucleotide chain, antibody, antigen and cyclodextrin.

In the biosubstance labeling agent of the invention, hydrophilized germanium nanoparticles of a core/shell structure are bonded to a molecular label substance via an organic molecule. Any organic molecule capable of allowing the germanium nanoparticles to be bonded to the molecular label substance is usable but of proteins, an albumin, myoglobin, casein and the like are preferable. Further, the use of a combination of avidin (being a protein) with biotin is also preferable. Modes of bonding are not specifically limited and include a covalent bond, ionic bond, hydrogen bond, coordination bond, physical adsorption and chemical adsorption. Strong bonding such as a covalent bond is preferred in terms of bonding stability.

Specifically, when Ge/GeO₂ nanoparticles are hydrophilized with mercaptoundecanoic acid, the combination of avidin and biotin are preferably used as the organic molecule. Thus, in the hydrophilized Ge/GeO₂ nanoparticles, a carboxyl group attached to the Ge/GeO₂ nanoparticles is suitably bonded to avidin; the avidin is further bonded selectively to biotin, while the biotin is bonded to a molecular label substance to form a biosubstance labeling agent.

### EXAMPLES

The present invention will be further described with reference to examples but the invention is by no means limited to these.

### Example 1

To a solution of 3.0 g of surfactant TOAB dissolved in 100 ml of toluene was dropwise added 100 μl of GeCl₄ with maintaining the temperature at 60° C. The solution was stirred for 2 hr. at 60° C. to form reversed micelles. Thereafter, 1 ml of a 1 M lithium aluminum hydride solution as a reducing agent was dropwise added and stirred for 0.5 hr. to form particulate germanium (Ge).

All solvents were removed from the obtained reaction mixture in a rotary evaporator to obtain solids containing particulate germanium. The obtained solids containing germanium microparticles were dispersed in 25 ml of hexane to form a dispersion. The dispersion was mixed with 100 ml of water and washed. Remaining reactants and bi-products were transferred to a water phase, while the germanium microparticles existed in a hexane phase. The reaction mixture was allowed to stand and the water phase was removed from the hexane phase to obtain a hexane dispersion of purified germanium microparticles. The thus obtained hexane dispersion of purified germanium microparticles was distilled in a rotary evaporator to obtain a dry powder of germanium microparticles. The dry powder was taken out and heated in ambient air at 400° C. for 0.1 hr. to perform oxidation of the particle surface to obtain 30 μg of Ge/GeO₂ type nanoparticles. Then, 10⁻⁵ g of this Ge/GeO₂ type nanoparticles was dispersed in an aqueous solution of 0.2 g of mercaptoundecanoic acid dissolved in 10 ml of pure water and stirred for 10 min. at 40° C. to obtain surface-hydrophilized Ge/GeO₂ type nanoparticles, which were designated as surface-hydrophilized Ge/GeO₂ nanoparticle No. 1.

The obtained surface-hydrophilized Ge/GeO₂ type nanoparticles were observed using a high-resolution transmission electron microscope (TEM), whereby formation of a core of Ge and a shell of GeO₂ were each confirmed. From TEM photographs were measured the average particle size (not including a carboxyl group) of the surface-hydrophilized Ge/GeO₂ nanoparticle 1, the average core particle size and the average shell thickness. The relationship of the weight ratio of raw materials and the core particle size is shown in Table 1, while the respective measurement results are shown in Table 2.

### Example 2

Surface-hydrophilized Ge/GeO₂ type nanoparticles (designated as Nanoparticle No. 2) was prepared similarly to the forgoing Nanoparticle No. 1 of Example 1, except that the amount of TOAB was changed from 3.0 g to 2.0 g.

The obtained surface-hydrophilized Ge/GeO₂ type nanoparticles were observed using a high-resolution transmission electron microscope (TEM) and formation of a core of Ge and a shell of GeO₂ were each confirmed. From TEM photographs were measured the average particle size (not including a carboxyl group) of the surface-hydrophilized Ge/GeO₂ nanoparticles 2, the average core particle size and the average shell thickness. The relationship of the weight ratio of raw materials and the core particle size is shown in Table 1, while the respective measurement results are shown in Table 2.

### Example 3

Surface-hydrophilized Ge/GeO₂ type nanoparticles (designated as nanoparticles No. 3) was prepared similarly to the forgoing Nanoparticle No. 1 of Example 1, except that the amount of TOAB was changed from 3.0 g to 1.0 g.

The obtained surface-hydrophilized Ge/GeO₂ type nanoparticles were observed using a high-resolution transmission electron microscope (TEM) and formation of a core of Ge and a shell of GeO₂ were each confirmed. From TEM photographs were measured the average particle size (not including a carboxyl group) of the surface-hydrophilized Ge/GeO₂ nanoparticles 3, the average core particle size and the average shell thickness. The relationship of the weight ratio of raw materials and the core particle size is shown in Table 1, and the respective measurement results are shown in Table 2.

### Comparative Example 1

Surface-hydrophilized Si/SiO₂ type nanoparticles (designated as Nanoparticle No. 4) were prepared similarly to the forgoing Nanoparticle No. 1 of Example 1, except that 100 μl of GeCl₄ was replaced by 80 μl of SiCl₄.

The obtained surface-hydrophilized Si/SiO₂ type nanoparticles were observed using a high-resolution transmission electron microscope (TEM) and formation of a core of Si and a shell of SiO₂ were each confirmed. From TEM photographs were measured the average particle size of the surface-hydrophilized Si/SiO₂ nanoparticles, the average core particle size and the average shell thickness. The relationship of the weight ratio of raw materials and the core particle size is shown in Table 1, and the respective measurement results are shown in Table 2.

TABLE 1

| | | Particle | Core | Shell |
|---|---|---|---|---|
| Nanoparticle | | Size | Size | Thickness |
| No. | Toluene:TOAB:GeCl₄*¹ | (nm) | (nm) | (nm) |
| 1 | 87:3.0:0.19 | 11.8 | 1.8 | 5.0 |
| 2 | 87:2.0:0.19 | 10.3 | 2.3 | 4.0 |
| 3 | 87:1.0:0.19 | 14.0 | 4.0 | 5.0 |
| 4 | 87:3.0:0.12*² | 14.2 | 2.2 | 6.0 |

*¹Weight ratio of Toluene:TOAB:GeCl₄
*²Weight ratio of Toluene:TOAB:SiCl₄

The thus obtained surface-hydrophilized Ge/GeO₂ type nanoparticles 1 to 3 and Si/SiO₂ were evaluated with respect to emission characteristics, in the following manner.

Using a Hitachi Spectrophotofluorometer F-7000, each of the foregoing nanoparticles was measured with respect to its emission spectrum at an excitation wavelength of 365 nm to determine an emission intensity at the peak (namely, the peak intensity). Further, variation in the emission spectrum with time was measured to compare the intensities at the start and after 1 hr. The intensity at the start was represented by a relative value, based on the intensity of the nanoparticles 1 being 100. The intensity after 1 hr. was also represented by a relative value, based on the intensity at the start being 100. Results are shown in Table 2.

TABLE 2

| | |
|---|---|
| Nanoparticle | Emission Intensity |

| No. | At start | After 1 hr |
|---|---|---|
| 1 | 100 | 96 |
| 2 | 105 | 98 |
| 3 | 108 | 94 |
| 4 | 76 | 85 |

### Example 4

To a dispersion of the surface-hydrophilized Ge/GeO₂ nanoparticles 1 was added 25 mg of avidin and stirred at 40° C. for 10 min. to obtain a dispersion of avidin-conjugated Ge/GeO₂ nanoparticles.

The obtained dispersion of avidin-conjugated Ge/GeO₂ nanoparticles was mixed with a biotin-attached oligonucleotides having a known base sequence to prepare a nanoparticle-labeled oligonucleotide.

The labeled oligonucleotide was dropwise added onto a DNA tip in which nucleotides of various base sequences were fixed and washed. It was proved that only a spot of an oligonucleotide of complementary base sequence to the labeled oligonucleotide exhibited emission upon exposure to ultraviolet rays, whereby labeling an oligonucleotide by nanoparticles was confirmed.

What is claimed is:

1. Core/shell nanoparticles, wherein the nanoparticles each comprise a core and a shell, the core comprises germanium (Ge) and the shell comprises an inorganic material, and the nanoparticles exhibiting an average core size of 1 to 50 nm.

2. The nanoparticles of claim 1, wherein the average core size is 1 to 20 nm.

3. The nanoparticles of claim 1, wherein the inorganic material is an inorganic compound other than said germanium (Ge).

4. The nanoparticles of claim 3, wherein the inorganic compound is germanium dioxide (GeO₂).

5. The nanoparticles of claim 1, wherein the nanoparticles exhibit an average shell thickness of 1 to 50 nm.

6. The nanoparticles of claim 1, wherein the nanoparticles exhibit an average particle size of 3 to 60 nm.

7. The nanoparticles of claim 1, wherein the nanoparticles were surface-modified with a surface modifying agent to enhance hydrophilicity of the surfaces of the nanoparticles.

8. The nanoparticles of claim 7, wherein the surface modifying agent is at least one selected from the group consisting of mercaptopropionic acid, mercaptoundecanoic acid and aminopropanethiol.

9. A biosubstance labeling agent comprising nanoparticle, wherein the nanoparticles are bonded to a molecular label substance through an organic molecule, and the nanoparticles are those as defined in claim 1.

10. The labeling agent of claim 9, wherein the nanoparticles were surface-modified with a surface modifying agent to enhance hydrophilicity of the surfaces of the nanoparticles.

11. The labeling agent of claim 10, wherein the surface modifying agent is at least one selected from the group consisting of mercaptopropionic acid, mercaptoundecanoic acid and aminopropanethiol.

12. The labeling agent of claim 9, wherein the molecular label substance is a nucleotide chain.

13. The labeling agent of claim 9, wherein the molecular label substance is an antibody.

14. The labeling agent of claim 9, wherein the organic molecule is at least one selected from the group consisting of an albumin, a myoglobin, a casein and avidin combined with biotin.

15. A method of preparing nanoparticles comprising a core and a shell, the method comprising the steps of:
(a) forming core particles and
(b) forming a shell on the surfaces on the core particles to form the nanoparticles,
wherein the nanoparticles are those defined in claim 1 and step (a) comprises the steps of
(a-1) dispersing a germanium salt and a surfactant in an organic solvent to form reversed micelles of the surfactant and including the germanium salt and
(a-2) reducing the germanium salt to form particles of germanium (Ge).

16. The method of claim 15, wherein the germanium salt is GeCl₄.

17. The method of claim 15, wherein the reducing agent is lithium aluminum hydride.

18. The method of claim 17, wherein in step (b), the particles of germanium (Ge) are oxidized to form the shell of germanium dioxide (GeO₂) on the surfaces of the particles of germanium (Ge).

19. The method of claim 1, wherein the method further comprises:
(c) subjecting the nanoparticles to a hydrophilization treatment to enhance hydrophilicity of the surfaces of the nanoparticles by bringing the nanoparticles into contact with a surface modifying agent.

20. The method of claim 19, wherein the surface modifying agent is at least one selected from the group consisting of mercaptopropionic acid, mercaptoundecanoic acid and aminopropanethiol.
